(19) United States
(12) Patent Application Publication
(10) Pub. No.: US 2017/0080621 A1
(43) Pub. Date: Mar. 23, 2017

(54) INJECTION MOLDING METHOD OF RESIN MOLDED ARTICLE AND SPECIFYING METHOD OF CLAMPING FORCE

(71) Applicant: OLYMPUS CORPORATION, Tokyo (JP)

(72) Inventor: Kazuhiro KIKUMORI, Kamiina-gun (JP)

(73) Assignee: OLYMPUS CORPORATION, Tokyo (JP)

(21) Appl. No.: 15/364,828

(22) Filed: Nov. 30, 2016

Related U.S. Application Data
(63) Continuation of application No. PCT/JP2015/060350, filed on Apr. 1, 2015.

(30) Foreign Application Priority Data
Jun. 4, 2014 (JP) 2014-116033

(51) Int. Cl. B29C 45/77; B29C 45/64; B29C 45/34

(52) U.S. Cl. CPC B29C 45/77; B29C 45/34; B29C 45/64

(57) ABSTRACT

An injection molding method of a resin molded article closes a first die and a second die by a predetermined clamping force, conducts pressure holding and cooling after filling a cavity formed between the first die and the second die with a molten resin, and opens the first die and the second die. The injection molding method conducts clamping, filling, pressure holding, and cooling for the first die and the second die by a clamping force previously specified on the basis of a sample with which pressure in the cavity during a cooling process indicates a minimum and which is specified from samples of clamping forces.

### CROSS-REFERENCE TO RELATED APPLICATIONS

This application is a Continuation Application of PCT Application No. PCT/JP2015/060350, filed Apr. 1, 2015 and based upon and claiming the benefit of priority from prior Japanese Patent Application No. 2014-116033, filed Jun. 4, 2014, the entire contents of all of which are incorporated herein by reference.

### BACKGROUND OF THE INVENTION

1. Field of the Invention

The present invention relates to an injection molding method of a resin molded article to mold the resin molded article such as a plastic lens, and a specifying method of a clamping force.

2. Description of the Related Art

In general, when clamping is conducted in a movable die and a fixed die of an injection molding die, clamping force is important in deciding the quality of a molded article. For example, when the clamping force is low, the clamping force loses to the pressure of a resin that is filled with a cavity of the injection molding die, and the die opens, leading to the generation of burrs. When the clamping force is too high, there is concern that gas may not be vented enough from the cavity during a filling process in which the cavity is filled with the molten resin. When the clamping force is too high, damage caused to the die by the clamping force and the deformation of the die caused by the damage lead to bad quality of the molded article and the decrease of the life of the die.

For example, in Jpn. Pat, Appln. KOKAI Publication No. 2012-206499, an optimum clamping force is specified on the basis of the relation between set clamping force and detected clamping force. A movable platen of a movable side die is coupled to a fixed platen of a fixed side die by tie bars which guide the movement of the movable platen. A clamping force sensor is provided in one tie bar. This clamping force sensor detects the strain of the tie bar, and the optimum clamping force is specified on the basis of detection data in this clamping force sensor.

### BRIEF SUMMARY OF THE INVENTION

An aspect according to an injection molding method of a resin molded article of the invention closes a first die and a second die by a predetermined clamping force, conducts pressure holding and cooling after filling a cavity formed between the first die and the second die with a molten resin, and opens the first die and the second die, the injection molding method conducts clamping, filling, pressure holding, and cooling for the first die and the second die by a clamping force previously specified on the basis of a sample with which pressure in the cavity during a cooling process indicates a minimum and which is specified from samples of clamping forces.

An aspect according to an injection molding method of a resin molded article of the invention closes a first die and a second die by a predetermined clamping force, conducts pressure holding and cooling after filling a cavity formed between the first die and the second die with a molten resin, and opens the first die and the second die, the injection molding method conducts clamping, filling, pressure holding, and cooling for the first die and the second die by substantially using, as a clamping force, a sample with which pressure in the cavity during a cooling process indicates a minimum and which is specified from samples of clamping forces.

An aspect according to an injection molding method of a resin molded article of the invention closes a first die and a second die by a predetermined clamping force, conducts pressure holding and cooling after filling a cavity formed between the first die and the second die with a molten resin, and opens the first die and the second die, the injection molding method maintains a contact state of contact surfaces of the first die and the second die in a clamping state of the first die and the second die on the basis of a measurement result of pressure during a cooling process for each of samples of clamping forces, inhibits the resin that fills the cavity from being discharged from the cavity to the outside via a micro depression portion formed to cut out the contact surface of at least one of the first die and the second die and via a discharge opening portion that communicates with the outside in the clamping state of the first die and the second die, and permits the discharge of a gas in the cavity, thereby conducting filling, pressure holding, and cooling by a clamping force which is specified because the pressure in the cavity during the cooling process indicates a minimum due to the inhibition and the discharge.

In an aspect according to a specifying method of a clamping force in injection molding of a resin molded article of the invention, the injection molding closes a first die and a second die by a predetermined clamping force, conducts pressure holding and cooling after filling a cavity formed between the first die and the second die with a molten resin, and opens the first die and the second die, the specifying method includes a specifying process to measure pressure in the cavity during a cooling process for each of samples of the clamping forces, and specify a clamping force with which the pressure in the cavity indicates a minimum on the basis of the measurement result.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an explanatory diagram illustrating an overview of an injection molding die to conduct an injection molding method of a resin molded article according to a first embodiment of the present invention;

FIG. 2 is a longitudinal sectional view showing, in a magnified form, the configuration of the vicinity of a cavity of the injection molding die according to the first embodiment;

FIG. 3 is a characteristic diagram showing a pressure waveform for one cycle of a molding process detected by a pressure sensor of the injection molding die according to the first embodiment;

FIG. 4 is a longitudinal sectional view showing a state where burrs are generated from a gas discharge opening of the injection molding die according to the first embodiment;

FIG. 5 is a longitudinal sectional view showing a state where the gas discharge opening of the injection molding die according to the first embodiment is blocked;

FIG. 6 is a flowchart showing a clamping force specifying process to specify proper clamping force of the injection molding die according to the first embodiment;

FIG. 7 is a characteristic diagram showing the relation between residual pressure and clamping force to illustrate the clamping force specifying process when proper clamping force of the injection molding die according to the first embodiment is specified;

FIG. 8 is a longitudinal sectional view showing a first modification of the injection molding die according to the first embodiment;

FIG. 9 is a longitudinal sectional view showing a second modification of the injection molding die according to the first embodiment;

FIG. 10 is a longitudinal sectional view showing a third modification of the injection molding die according to the first embodiment;

FIG. 11 is an explanatory diagram illustrating an overview of an injection molding die to conduct an injection molding method of a resin molded article according to a second embodiment of the present invention;

FIG. 12 is a flowchart showing a clamping force specifying process to specify proper clamping force of a multi-cavity injection molding die according to the second embodiment; and

FIG. 13 is a characteristic diagram showing the relation between residual pressure and clamping force to illustrate the clamping force specifying process when proper clamping force of the multi-cavity injection molding die according to the second embodiment is specified.

### DETAILED DESCRIPTION OF THE INVENTION

### First Embodiment

### Configuration

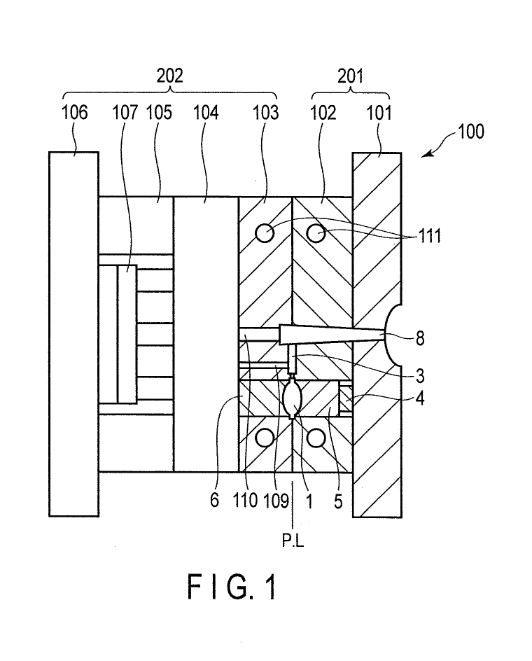

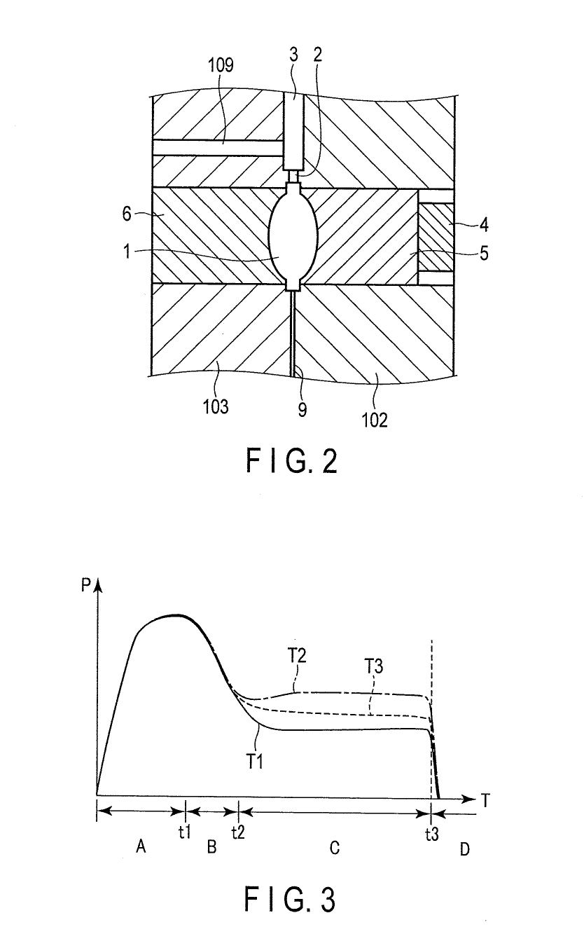

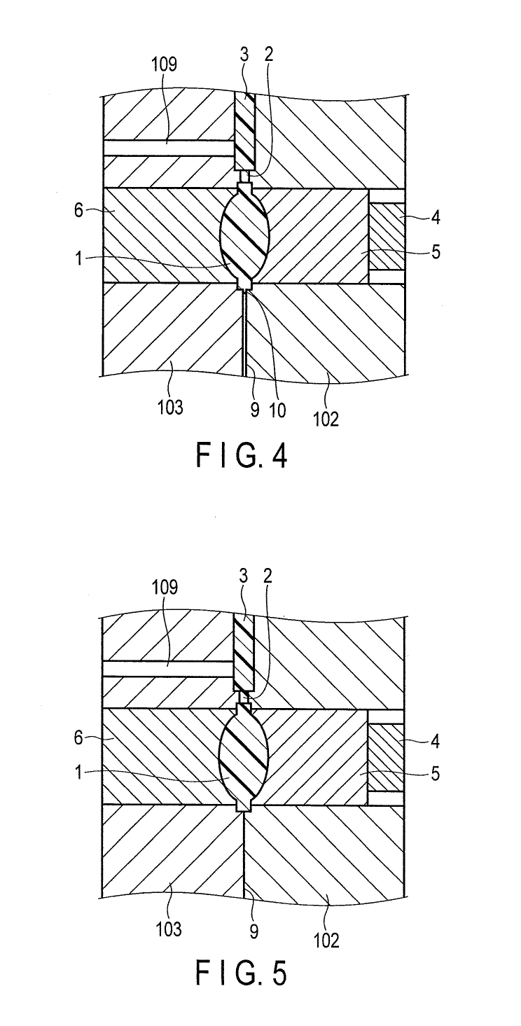

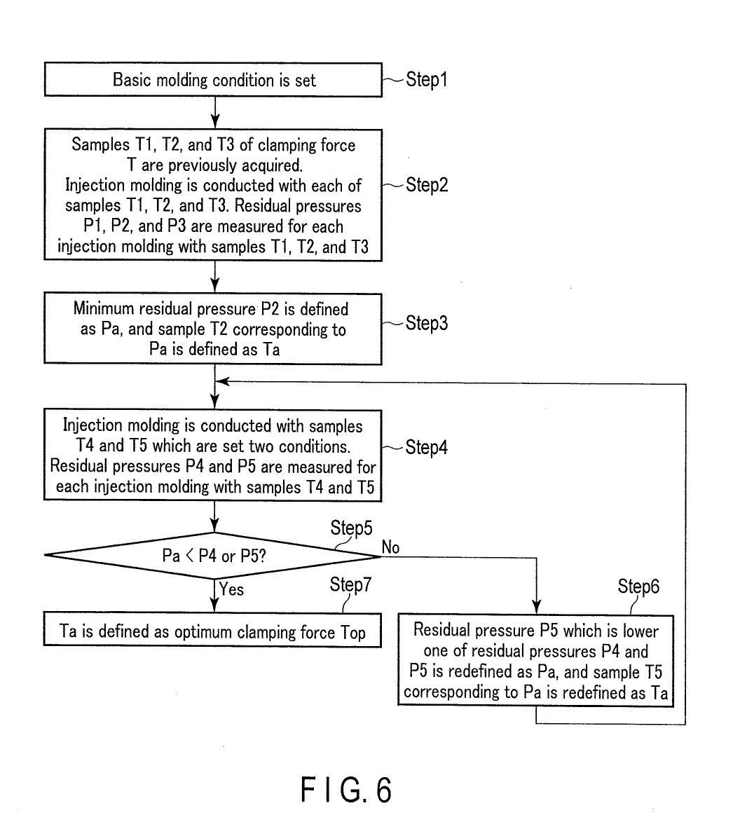

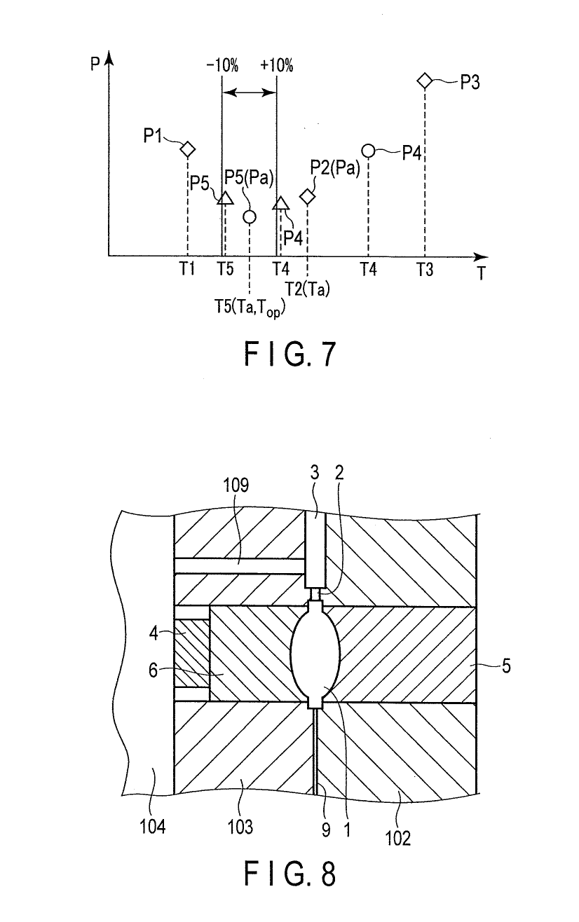

FIG. 1, FIG. 2, FIG. 3, FIG. 4, FIG. 5, FIG. 6, and FIG. 7 show a first embodiment of the present invention. In the present embodiment, an optical element is illustrated as a resin molded article by way of example.

As shown in FIG. 1, an injection molding die 100 has a fixed die 201 and a movable die 202 that are disposed to face each other across a parting line (hereinafter referred to as a P.L). The fixed die 201 is an example of a first die, and the movable die 202 is an example of a second die. The fixed die 201 and the movable die 202 are attached to platens of an unshown injection molding machine, respectively. The movable die 202 opens/closes relative to the fixed die 201 across the P.L in response to an open/close operation of the injection molding machine to which the movable die 202 is attached.

As shown in FIG. 1, the fixed die 201 has a fixed clamping plate 101 and a fixed die plate 102. The fixed clamping plate 101 and the fixed die plate 102 are main bodies of the fixed die 201. As shown in FIG. 2, a fixed insert 5 which is an insert that constitutes a part of a cavity 1 for the molded article is inserted in the fixed die plate 102. As shown in FIG. 1, the movable die 202 has a movable die plate 103, a movable support plate 104, a spacer block 105, a movable clamping plate 106, and a ejector plate 107. The movable die plate 103, the movable support plate 104, the spacer block 105, the movable clamping plate 106, and the ejector plate 107 are main bodies of the movable die 202. As shown in FIG. 2, a movable insert 6 which is an insert that constitutes a part of the cavity 1 for the molded article is inserted in the movable die plate 103. The movable insert 6 faces the fixed insert 5 across the P.L.

When the injection molding die 100 molds the molded article, the movable die 202 closes relative to the fixed die 201 in a die close process. Accordingly, the cavity 1 is formed by the fixed die plate 102, the fixed insert 5, the movable die plate 103, and the movable insert 6. As shown in FIG. 1 and FIG. 2, in a filling process, this cavity 1 is filled with a molten resin from the unshown injection molding machine via a sprue 8, a runner 3, and a gate 2. Pressure holding is then conducted for the injection molding die 100 including the molten resin in a pressure holding process, and cooling is conducted for the injection molding die 100 including the molten resin in a cooling process. Accordingly, the molten resin is solidified, and a desired molded article is formed. In a die open and takeout process, the movable die 202 then opens relative to the fixed die 201, and the molded article is taken out of the cavity 1. A process from the die close process to the die open and takeout process is one cycle of injection molding.

As shown in FIG. 2, the injection molding die 100 has a gas discharge opening portion 9 which communicates with the cavity 1. The gas discharge opening portion 9 is formed by cutting out at least one of a contact surface of the fixed die 201 for the movable die 202 and a contact surface of the movable die 202 for the fixed die 201. The gas discharge opening portion 9 has a micro depression portion which is a main body of the gas discharge opening portion 9, and a discharge opening portion which is an end portion of the gas discharge opening portion 9 and which is continuous with the micro depression portion. When the movable die 202 is closed relative to the fixed die 201, the gas discharge opening portion 9 communicates with the cavity 1 and an outside of the injection molding die 100. When the cavity 1 is filled with the molten resin in the filling process, air in the cavity 1 and a gas generated from the molten resin are appropriately discharged to the outside from the gas discharge opening portion 9 due to an operation in which the molten resin is pressed into the cavity 1.

The temperature necessary for the solidification of the molten resin filling the cavity 1 is controlled by a cooling medium. The cooling medium flows through a temperature regulation channel 111 formed in the fixed die 201 and the movable die 202 shown in FIG. 1. The temperature of the cooling medium is controlled at a predetermined temperature by an unshown temperature regulator. The cooling medium is, for example, water or oil.

As shown in FIG. 1, the movable die 202 has ejector pins 109 and 110 to take the molded article out of the movable die 202 in the die open and takeout process. The proximal end portions of the ejector pins 109 and 110 are coupled to the ejector plate 107. After the movable die 202 opens relative to the fixed die 201 in the die open and takeout process, the ejector plate 107 moves in a direction (closing direction) opposite to the direction in which the movable die 202 opens, together with an operation of the unshown injection molding machine. The ejector pins 109 and 110 push the molded article out of the movable die 202 in the movement direction of the ejector plate 107 due to the movement of the ejector plate 107. As a result, the molded article is taken out of the movable die 202.

As shown in FIG. 1, the injection molding die 100 has a detector which detects pressure inside the cavity 1. The detector has a pressure sensor 4 which is disposed between the fixed insert 5 and the fixed clamping plate 101. In an injection molding method according to the present embodiment, when the cavity 1 is filled with the molten resin in the filling process, pressure P of the resin in the cavity 1 is detected by the pressure sensor 4. In other words, the pressure P of the resin refers to, for example, pressure which is put on the cavity 1 by the molten resin. The cooling process has a measurement process to measure detection data detected by the pressure sensor 4. The detection data includes information regarding the detected pressure P. The measurement process includes a specifying process to measure the pressure P in the cavity 1 during the cooling process for each of previously acquired samples of clamping forces T which are different from one another, and specify a proper clamping force on the basis of a measurement result of the pressure P in the cavity 1 during the cooling process.

(Functions)

An example of a procedure of conducting the injection molding method of the resin molded article according to the present embodiment is shown below by use of FIG. 3, FIG. 4, FIG. 5, FIG. 6, and FIG. 7. In FIG. 3, a reference mark A is a region of the filling process in which the cavity 1 is filled with the molten resin, a reference mark B is a region of the pressure holding process, a reference mark C is a region of the cooling process, and a reference mark D is a region of the die open and takeout process. t1 indicates an end point of the filling process and a start point of the pressure holding process, t2 indicates an end point of the pressure holding process and a start point of the cooling process, and t3 indicates an end point of the cooling process and a start point of die opening.

As shown in FIG. 3, the pressure P of the resin generally increases as the resin fills the cavity 1. After the completion of the filling process A, the pressure P of the resin filling the cavity 1 decreases as the process proceeds to the pressure holding process B and the cooling process C. However, in the cooling process C, the pressure P does not completely reach zero, and certain pressure remains (hereinafter, this pressure is referred to as residual pressure). This residual pressure is one factor that determines the quality of the molded article.

The present inventor has found that the magnitude of the residual pressure is related to the “clamping force” which is the force to close the fixed die 201 and the movable die 202 by the unshown injection molding machine. The present inventor has also confirmed that the quality of the molded article is the highest when molding is conducted by the clamping force specified so that the residual pressure may be the minimum.

Specifically, when this clamping force is too low, a pressure waveform indicates T2 in FIG. 3. Here, the clamping force loses to the pressure P of the resin during the filling process, and the fixed die 201 and the movable die 202 open with respect to the P.L. As a result, not only the gas but also the molten resin is discharged from the gas discharge opening portion 9. Consequently, as shown in FIG. 4, burrs 10 are generated, and the molded article becomes defective. The pressure then decreases as the process proceeds to the pressure holding process B and the cooling process C. The fixed die 201 and the movable die 202 that are open will then be restored, so that the resin is compressed, and the residual pressure of the resin filling the cavity 1 becomes high.

On the contrary, when the clamping force is too high, a pressure waveform indicates T3 in FIG. 3. As shown in FIG. 5, the dies (the fixed die 201 and the movable die 202) are deformed by the extremely high clamping force, and the gas discharge opening portion 9 is blocked by the deformation. In this case, in the filling process, the gas is not vented enough to the outside through the gas discharge opening portion 9, and the pressure in the cavity 1 is higher. This leads to problems such as a transfer failure and gas burning in the molded article. Moreover, there is a possibility of shorter lives of the dies, for example, the deformation of the dies and the abrasion of the dies because of the excessively high clamping force.

When the clamping force is optimum, a pressure waveform indicates T1 in FIG. 3. Here, at T1, T2, and T3, the residual pressure reaches a minimum at T1. In this case, when the cavity 1 is filled with the resin, no burrs are generated, and the molded article is molded by the clamping force that allows the gas to be vented well, so that the quality of the molded article is the best.

A clamping force specifying process to specify an optimum clamping force Top according to the present embodiment is described with reference to FIG. 6 and FIG. 7.

A basic molding condition of the injection molding die 100 other than clamping force T is set (Step 1). Samples T1, T2, and T3 of the clamping force T are then previously acquired. The samples are at least three conditions, and are values different from one another. Injection molding is conducted with each of the samples T1, T2, and T3. In this instance, the pressure P is measured by the pressure sensor 4 for each injection molding with the samples T1, T2, and T3 (Step 2). In FIG. 7, the residual pressure in the case of the injection molding with the sample T1 is P1, the residual pressure in the case of the injection molding with the sample T2 is P2, and the residual pressure in the case of the injection molding with the sample T3 is P3. In FIG. 7, P1, P2, and P3 in Step 2 are indicated by ⋄. Among the residual pressures P1, P2, and P3 measured in Step 2, P2 which is the minimum residual pressure, for example, is defined as Pa, and the sample T2 corresponding to Pa is defined as Ta (Step 3). Steps 2 and 3 are a first process to specify the sample T2 that indicates a minimum on the basis of a measurement result of the pressure in the cavity 1 in a first sample group comprising the samples T1, T2, and T3 of the clamping forces.

Samples (two conditions) that are higher and lower than Ta are then set. Thus, T4 which is a sample of the clamping force higher than Ta, and T5 which is a sample of the clamping force lower than Ta are set. The sample T4 is lower than the sample T3, and the sample T5 is higher than the sample T1. Injection molding is conducted with the samples T4 and T5 which are the set two conditions. In this instance, the pressure P is measured by the pressure sensor 4 for each injection molding with the samples T4 and T5 (Step 4). Here, as shown in FIG. 7, the residual pressure in the case of the injection molding with the sample T4 is P4, and the residual pressure in the case of the injection molding with the sample T5 is P5. In FIG. 7, P4 and P5 in Step 4 are indicated by O.

Whether Pa<P4 or P5 is then judged (Step 5). If the relation is Pa>P4 or P5 in Step 5, the procedure proceeds to Step 6. In Step 6, the residual pressure P5 which is lower one of the residual pressures P4 and P5 is redefined as Pa, and the sample T5 corresponding to the residual pressure Pa is redefined as Ta. The procedure then returns to Step 4. Here, the content indicating that the residual pressures P2 defined above is Pa, and the content indicating that the sample T2 is Ta are erased. In Step 4, the samples T4 and T5 are reset in two conditions for Ta that has been redefined, and the same is repeated. The residual pressure in the case of the injection molding with the sample T4 is P4, and the residual pressure in the case of the injection molding with the sample T5 is P5. In FIG. 7, the residual pressures P4 and P5 in Step 4 after Step 6 are indicated by Δ.

In Step 5, the relation between Pa indicated by O in FIG. 7 and the residual pressures P4 and P5 indicated by Δ in FIG. 7 is checked, and whether Pa<P4 or P5 is then judged. If the relation is Pa<P4 or P5, Ta is defined as the optimum clamping force Top (Step 7). In this way, the optimum clamping force Top with which the residual pressure Pa will be finally the minimum is specified. Steps 4, 5, 6, and 7 specify, as the optimum clamping force Top, the sample T5 that indicates a minimum on the basis of the measurement result of pressure in the cavity 1 in a second sample group including the specified sample T2 in the first process, the sample T4 too higher than the specified sample T2, and the sample T5 lower than the specified sample T2.

In the actual molding (clamping, filling, pressure holding, and cooling), the optimum clamping force Top is not selected, and clamping force around the optimum clamping force Top is set, and molding is conducted by this set clamping force. This clamping force is not the optimum clamping force Top, and is a tolerable clamping force that is present within a tolerance of, for example, ±10% for the optimum clamping force Top. Molding (clamping, filling, pressure holding, and cooling) may be conducted with the optimum clamping force Top. Thus, for example, the optimum clamping force Top and the tolerable clamping force are clamping forces which are previously specified on the basis of the samples with that the pressure in the cavity 1 during the cooling process indicates a minimum and that is specified from the samples of the clamping forces. For example, the tolerable clamping force is substantially used as a sample with which the pressure in the cavity 1 during the cooling process indicates a minimum and which is specified from the samples of the clamping forces. The clamping force specifying process measures the pressure in the cavity 1 during the cooling process for each of the samples of the clamping forces, and specifies the optimum clamping force Top and the tolerable clamping force with which the pressure in the cavity 1 indicates a minimum on the basis of the measurement result. The specifying process specifies, as the optimum clamping force Top, the sample that indicates a minimum in the measurement result of the pressure in the cavity 1 in each sample. Moreover, the injection molding method according to the present embodiment closes the fixed die 201 and the movable die 202 by a predetermined clamping force, conducts the pressure holding and cooling after filling the cavity 1 formed between the fixed die 201 and the movable die 202 with the molten resin, and opens the fixed die 201 and the movable die 202. The injection molding method maintains the contact state of the contact surfaces of the fixed die 201 and the movable die 202 in a clamping state of the fixed die 201 and the movable die 202 on the basis of the measurement result of the pressure during the cooling process for each of the samples of the clamping forces. The injection molding method inhibits the resin that fills the cavity 1 from being discharged from the cavity 1 to the outside via the micro depression portion (the main body of the gas discharge opening portion 9) formed to cut out the contact surface of at least one of the fixed die 201 and the movable die 202 and via a discharge opening portion (the end portion of the gas discharge opening portion 9) that communicates with the outside in the clamping state of the fixed die 201 and the movable die 202, and permits the discharge of the gas in the cavity 1. The optimum clamping force Top and the tolerable clamping force are specified as clamping forces with which the pressure in the cavity 1 during the cooling process indicates a minimum due to the inhibition and the discharge.

The tolerance of the optimum clamping force is set at ±10% in the present embodiment, but is not limited thereto. The tolerance may be changed in accordance with, for example, the quality required for the molded article. The fluctuation width (the variation width of a set value) of the clamping force and how to bring to the minimum value may also be set in accordance with, for example, the quality required for the molded article. The fluctuation width indicates, for example, T4 and T5 with respect to T2. How to bring to the minimum value indicates, for example, the number of times of Steps 4, 5, and 6. The optical element has been described as the resin molded article by way of example in the present embodiment, but the resin molded article is not limited thereto.

### Advantageous Effects

The configuration described above has the following advantageous effects. That is, in the injection molding method of the resin molded article according to the present embodiment, the optimum clamping force is specified for the quality and shape of the molded article, and the molded article is molded by this clamping force, whereby the molded article of good quality is obtained. The pressure sensor 4 detects the pressure of the resin applied on the cavity 1 which defines the shape of the molded article. The pressure sensor 4 is disposed between the fixed insert 5 and the fixed clamping plate 101. In the pressure of the resin detected by the pressure sensor 4, the clamping force T with which the pressure during the cooling process may be the minimum is specified, and molding (clamping, filling, pressure holding, and cooling) is conducted with this clamping force T. Thus, the molded article can be molded with proper clamping force. Because excessive clamping force is not applied to the molded article, the life of the injection molding die 100 is improved. It is therefore possible to provide an injection molding method of a resin molded article and a specifying method of a clamping force whereby a resin molded article such as a plastic lens can be molded without any transfer failure and without the generation of burrs.

[Modifications]

In a first modification shown in FIG. 8, the pressure sensor 4 is disposed between the movable insert 6 and the movable support plate 104. When the pressure sensor 4 can not be installed in the fixed die 201 because of the configuration of the injection molding die, the pressure sensor 4 may be disposed in the movable die 202.

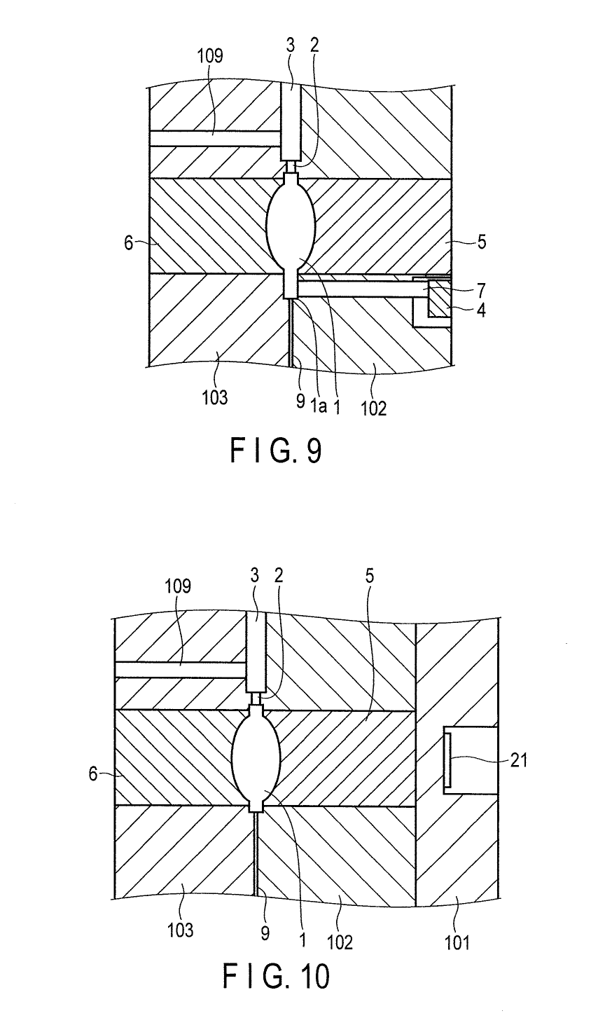

In a second modification shown in FIG. 9, the pressure sensor 4 is not disposed behind the fixed insert 5 which forms an optical functional surface of an optical element such as a resin lens. The pressure sensor 4 detects, for example, the pressure of parts other than the optical functional surface of the optical element (e.g. a flange portion 1a of the optical element disposed on the outer circumference of the optical functional surface). Thus, a pin 7 which is a main body of the fixed die 201 is disposed in a part of the fixed die plate 102 corresponding to the flange portion 1a, and the pressure sensor 4 is disposed behind the pin 7. The pressure sensor 4 detects the pressure in the flange portion 1a via the pressure that acts on the pin 7. The present modification can cope with cases in which there is a possibility that some problem may occur when the pressure sensor 4 is disposed in the fixed insert 5.

In a third modification shown in FIG. 10, a strain sensor 21 is attached to the fixed clamping plate 101 instead of the pressure sensor 4. In the present modification, stress on the cavity 1, for example, is detected by the strain sensor 21, and the optimum clamping force is specified. When the pressure sensor 4 according to the first embodiment can not be installed in the injection molding die 100, force applied to the cavity 1 from the outside of the injection molding die 100 can be indirectly detected by the strain sensor 21 in the present modification. Thus, the configuration of the injection molding die 100 can be simpler.

### Second Embodiment

### Configuration

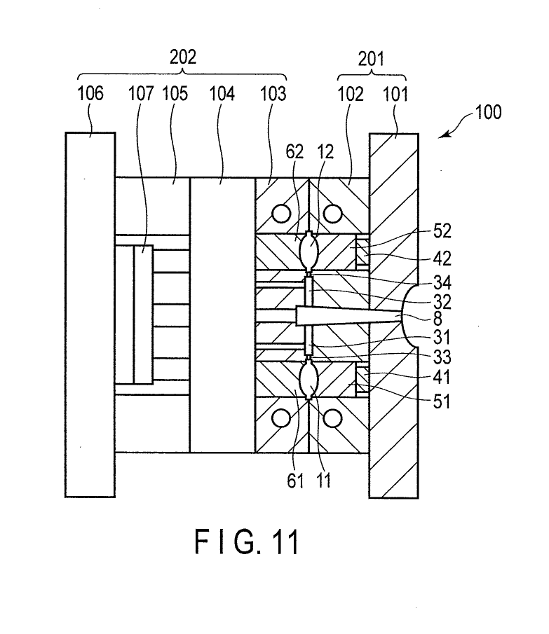

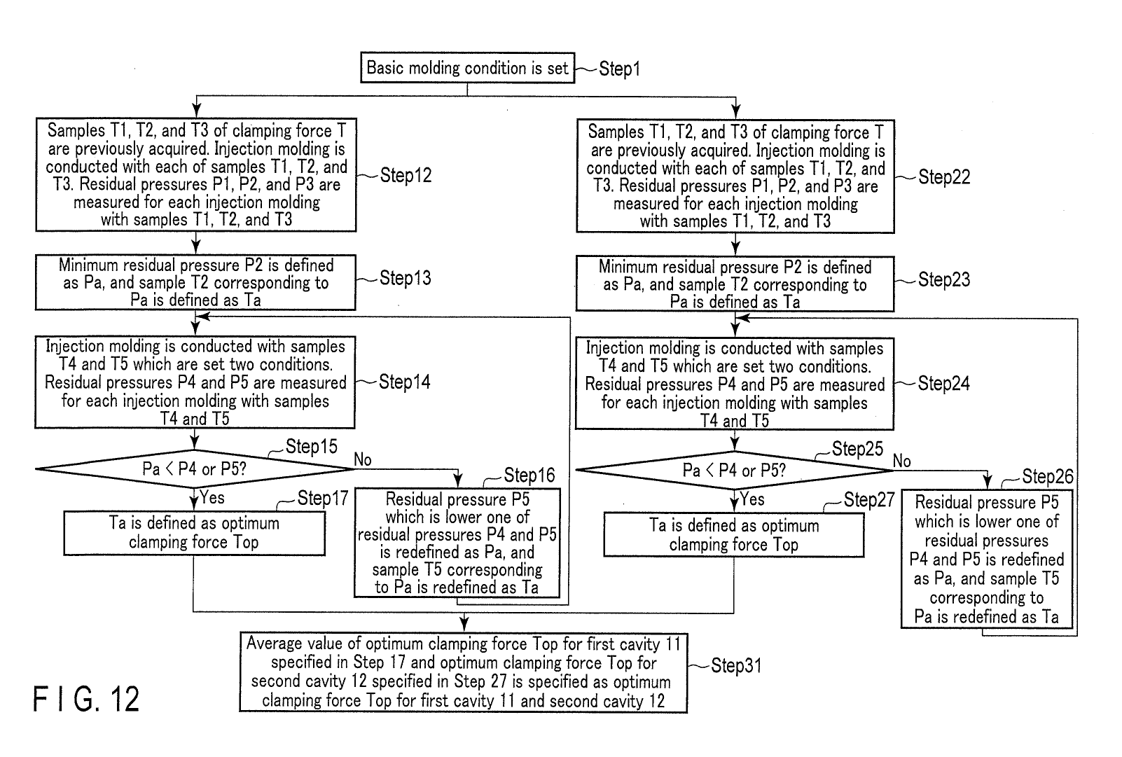

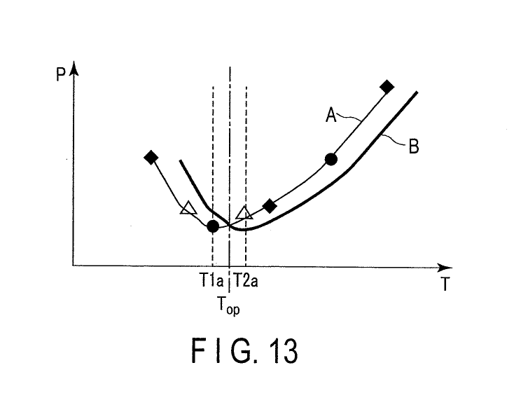

A second embodiment of the present invention is described with reference to FIG. 11, FIG. 12, and FIG. 13. The present embodiment is a modification in which the configuration of the injection molding die 100 according to the first embodiment is modified as follows. That is, in the first embodiment, one injection molding die 100 is a single-cavity injection molding die which comprises one cavity 1 and which molds one molded article in one injection molding. In the present embodiment, one injection molding die 100 is a multi-cavity injection molding die 100 which comprises more than one cavity 1 and which molds more than one molded article in one injection molding. The injection molding die 100 according to the present embodiment is a two-cavity injection molding die 100. In the present embodiment, the same parts as those in the first embodiment are indicated with the same reference marks and are not described.

In the present embodiment, two fixed inserts (a first fixed insert 51 and a second fixed insert 52) are inserted in the fixed die plate 102. These fixed inserts form a part of the cavity 1 for the molded article. Two movable inserts (a first movable insert 61 and a second movable insert 62) are inserted in the movable die plate 103. These movable inserts form a part of the cavity 1 for the molded article. A first cavity 11 is formed between the first fixed insert 51 and the first movable insert 61. A second cavity 12 is formed between the second fixed insert 52 and the second movable insert 62.

The sprue 8 is disposed in a central part of the fixed die plate 102. This sprue 8 is coupled to each of the proximal end portions (inner end portions) of two runners (a first runner 31 and a second runner 32). The distal end portion (outer end portion) of the first runner 31 is coupled to the first cavity 11 via a first gate 33. The distal end portion (outer end portion) of the second runner 32 is coupled to the second cavity 12 via a second gate 34.

A first pressure sensor 41 which is a detector is disposed between the first fixed insert 51 and the fixed clamping plate 101. A second pressure sensor 42 which is a detector is disposed between the second fixed insert 52 and the fixed clamping plate 101. The first pressure sensor 41 detects the pressure P of the resin when the first cavity 11 is filled with the resin, and the second pressure sensor 42 detects the pressure P of the resin when the second cavity 12 is filled with the resin.

The present embodiment has the clamping force specifying process in each of the first cavity 11 and the second cavity 12. The present embodiment also has a multi-cavity clamping force specifying process to define, as proper clamping force, an average value of the optimum clamping force specified for the first cavity 11 and the optimum clamping force specified for the second cavity 12.

(Functions)

Next, functions of the above configuration are described. In the case of the multi-cavity injection molding die 100 according to the present embodiment, the pressure waveform in the first cavity 11 is ideally the same as the pressure waveform in the second cavity 12. However, in general, the injection molding die 100 has molding errors and a difference. This difference is the difference between how to fill the first cavity 11 with the resin due to the molding errors and how to fill the second cavity 12 with the resin due to the molding errors. Thus, the pressure waveform in the first cavity 11 and the pressure waveform in the second cavity 12 do not necessarily correspond to each other. Consequently, as shown in FIG. 13, there occurs a phenomenon in which a characteristic curve A of the residual pressure in the first cavity 11 compared to the clamping force differs from a characteristic curve B of the residual pressure in the second cavity 12.

A clamping force specifying process to specify the optimum clamping force Top according to the present embodiment is described with reference to FIG. 12.

Step 1 is conducted. The clamping force specifying process is then conducted for the first cavity 11 and the second cavity 12. The clamping force specifying process for the first cavity 11 has Steps 12, 13, 14, 15, 16, and 17. Steps 12, 13, 14, 15, 16, and 17 correspond to Steps 2, 3, 4, 5, 6, and 7. The clamping force specifying process for the second cavity 12 has Steps 22, 23, 24, 25, 26, and 27. Steps 22, 23, 24, 25, 26, and 27 correspond to Steps 2, 3, 4, 5, 6, and 7. Steps 12, 13, 14, 15, 16, and 17 and Steps 22, 23, 24, 25, 26, and 27 may be conducted at the same time, or may be conducted in turn.

After Step 17 and Step 27, an average value of the optimum clamping force Top for the first cavity 11 specified in Step 17 and the optimum clamping force Top for the second cavity 12 specified in Step 27 is specified as the optimum clamping force Top for the first cavity 11 and the second cavity 12 (Step 31). The average value is clamping force which is previously specified on the basis of a sample with that the pressure in the cavity during the cooling process indicates a minimum and that is specified from more than one samples.

### Advantageous Effects

Thus, in the present embodiment, in addition to the advantageous effects according to the first embodiment, the optimum clamping force can be specified as a whole even in the multi-cavity injection molding die.

It should be understood that the present invention is not limited to the embodiments described above and that various modifications can be made without departing from the spirit of the present invention.

Additional Note (1)

An injection molding die to conduct a molding method of a resin molded article, the molding method comprising a filling process in which a cavity is filled with a molten resin, a pressure holding process, a cooling process, and a die open process,

the injection molding die comprising a detector which detects pressure in the cavity,

the injection molding die measuring detection data from the detector during the cooling process,

the injection molding die measuring pressure in the cavity during the cooling process for each of previously acquired samples of clamping forces which are different from one another,

the injection molding die specifying the clamping forces by the measurement result of the pressure in the cavity during the cooling process.

Additional Note (2)

The injection molding die according to Additional Note (1), wherein the detector comprises a pressure sensor disposed between at least one of inserts of a fixed die and a movable die which constitute a part of the cavity, and a main body of the one insert.

Additional Note (3)

The injection molding die according to Additional Note (1), wherein the detector comprises a pressure sensor which detects pressure acting on a main body of a fixed die or a movable die other than inserts of the fixed die and the movable die that constitute a part of the cavity.

The present invention is not limited directly to the above-described embodiments. At the stage of practicing the invention, the structural elements may be modified and embodied without departing from the spirit of the invention. Various inventions may be made by suitably combining a plurality of structural elements disclosed in the embodiments.

What is claimed is:

1. An injection molding method of a resin molded article to close a first die and a second die by a predetermined clamping force, conduct pressure holding and cooling after filling a cavity formed between the first die and the second die with a molten resin, and open the first die and the second die,
the injection molding method conducting clamping, filling, pressure holding, and cooling for the first die and the second die by a clamping force previously specified on the basis of a sample with which pressure in the cavity during a cooling process indicates a minimum and which is specified from samples of clamping forces.

2. An injection molding method of a resin molded article to close a first die and a second die by a predetermined clamping force, conduct pressure holding and cooling after filling a cavity formed between the first die and the second die with a molten resin, and open the first die and the second die,
the injection molding method conducting clamping, filling, pressure holding, and cooling for the first die and the second die by substantially using, as a clamping force, a sample with which pressure in the cavity during a cooling process indicates a minimum and which is specified from samples of clamping forces.

3. An injection molding method of a resin molded article to close a first die and a second die by a predetermined clamping force, conduct pressure holding and cooling after filling a cavity formed between the first die and the second die with a molten resin, and open the first die and the second die,
the injection molding method maintaining a contact state of contact surfaces of the first die and the second die in a clamping state of the first die and the second die on the basis of a measurement result of pressure during a cooling process for each of samples of clamping forces, inhibiting the resin that fills the cavity from being discharged from the cavity to the outside via a micro depression portion formed to cut out the contact surface of at least one of the first die and the second die and via a discharge opening portion that communicates with the outside in the clamping state of the first die and the second die, and permitting the discharge of a gas in the cavity, thereby conducting filling, pressure holding, and cooling by a clamping force which is specified because the pressure in the cavity during the cooling process indicates a minimum due to the inhibition and the discharge.

4. A specifying method of a clamping force in injection molding of a resin molded article to close a first die and a second die by a predetermined clamping force, conduct pressure holding and cooling after filling a cavity formed between the first die and the second die with a molten resin, and open the first die and the second die,
the specifying method comprising a specifying process to measure pressure in the cavity during a cooling process for each of samples of the clamping forces, and specify a clamping force with which the pressure in the cavity indicates a minimum on the basis of the measurement result.

5. The specifying method according to claim 4, wherein the specifying process comprises
a first process to specify a sample which indicates a minimum on the basis of the measurement result of the pressure in the cavity in a first sample group comprising the samples of the clamping forces, and
a second process to specify, as the clamping force, the sample which indicates a minimum on the basis of the measurement result of the pressure in the cavity in a second sample group including the specified sample in the first process, a sample too higher than the specified sample and a sample lower than the specified sample.
